(19) United States
(12) Patent Application Publication
(10) Pub. No.: US 2026/0283196 A1
(43) Pub. Date: Sep. 24, 2026

(54) FOOD COMPOSITIONS, SYSTEMS, AND METHODS

(71) Applicant: Mars, Incorporated, McLean, VA (US)

(72) Inventors: Taylor RICHARDS, Guelph (CA); Jennifer SAUNDERS-BLADES, St. Alberta (CA); Anna Katharine SHOVELLER, Guelph (CA)

(21) Appl. No.: 19/570,034

(22) Filed: Mar. 17, 2026

Related U.S. Application Data
(60) Provisional application No. 63/773,767, filed on Mar. 18, 2025.

(51) Int. Cl. A23K 50/42; A23K 20/142; A23K 50/20; A23K 50/48

(52) U.S. Cl. CPC A23K 50/42; A23K 20/142; A23K 50/20; A23K 50/48

(57) ABSTRACT

A method of promoting wellbeing of a companion animal including administering to the companion animal a food composition comprising at least one supplement. The at least one supplement includes creatine, guanidinoacetate, arginine, methionine, or a combination thereof. The food composition may be formulated as a dry kibble, a wet food, a treat, or a dietary supplement. Promoting wellbeing may comprise improving muscle composition, enhancing exercise performance, supporting muscle recovery, increasing energy expenditure, increasing lean body mass, supporting cardiac health, enhancing cognition, or reducing inflammation.

### CROSS-REFERENCE TO RELATED APPLICATIONS

This application claims the benefit of priority to U.S. Application No. 63/773,767, filed on Mar. 18, 2025, the entirety of which is incorporated herein by reference.

### FIELD OF DISCLOSURE

The present disclosure relates to companion animal nutrition and dietary supplementation and, more, particularly to food compositions comprising creatine or guanidinoacetate for modulating amino acid metabolism, energy expenditure, and physiological parameters in cats.

### BACKGROUND

The wellbeing of pets is under increased focus, particularly with respect to possible solutions to increase the quality of life. Muscle mass and cognition are two critical factors in maintaining a pet's overall health. As pets age, cognitive decline and loss of muscle mass can negatively affect their daily functioning and independence. Cognitive dysfunction in pets can manifest as confusion, disorientation, and changes in behavior, often due to a combination of genetic factors, aging, and environmental stressors. Similarly, the gradual loss of muscle mass, a condition known as sarcopenia, can lead to reduced mobility, weakness, and a reduced ability to performance normal activities. This loss of muscle mass can also lead to reduced physical activity, further exacerbating the condition and potentially leading to weight gain.

Addressing these issues through proper nutrition and supplementation can be beneficial for all animals, but especially for senior and working/performance animals, who have greater demands for muscle maintenance and cognitive function-whether due to age-related decline or an increased demand as a result of the physical and mental challenges of their roles. However, supplementing a pet's diet presents various challenges. For example, vitamins and other supplements can often be difficult to formulate in wet and dry foods developed for the pet food market. Additionally, storage and processing are concerns that can negatively impact efficacy, quality, and integrity of the food. Further, pets may be unwilling to consume food that is not palatable due to the presence of different food additives.

Accordingly, there exists an opportunity for improved food compositions and methods for modulating amino acid metabolism, energy expenditure, and physiological parameters in companion animals.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method of promoting wellbeing of a companion animal is provided. The method includes administering to the companion animal a food composition that includes at least one supplement. The at least one supplement includes creatine, guanidinoacetate, arginine, methionine, or a combination thereof.

According to other aspects of the present disclosure, the method may include one or more of the following features. The companion animal may be selected from a cat, a horse, a rabbit, a ferret, or a guinea pig. The at least one supplement may include creatine at a concentration from about 0.001% to about 1% by weight of the food composition. The at least one supplement may include creatine at a concentration from about 0.001% to about 2% by weight of the food composition. The at least one supplement may include guanidinoacetate at a concentration from about 0.001% to about 1% by weight of the food composition. The at least one supplement may be provided at a dosing range from about 10 mg to about 400 mg per kg of body weight of the companion animal. Promoting wellbeing may include at least one of improving muscle composition, enhancing exercise performance, supporting muscle recovery, increasing energy expenditure, increasing lean body mass, supporting cardiac health, enhancing cognition, or reducing inflammation. Promoting wellbeing may include increasing fatty acid oxidation. The food composition may be formulated as a dry kibble, a wet food, a treat, or a dietary supplement. The at least one supplement may include guanidinoacetate, and the method may further include supplementation with excess methionine to support conversion of the guanidinoacetate to creatine. The at least one supplement may include creatine, and administering the food composition may result in an arginine sparing effect in the companion animal.

According to another aspect of the present disclosure, a food composition for a companion animal is provided. The food composition includes a base diet. The food composition includes at least one supplement selected from the group consisting of creatine, guanidinoacetate, arginine, methionine, and combinations thereof. The at least one supplement is present at a concentration of at least 0.001% by weight of the food composition.

According to other aspects of the present disclosure, the food composition may include one or more of the following features. The at least one supplement may include creatine at a concentration from about 0.001% to about 1% by weight of the food composition. The at least one supplement may include guanidinoacetate at a concentration from about 0.001% to about 1% by weight of the food composition. The guanidinoacetate may exhibit losses of less than 1% post-extrusion and less than 10% after storage at 25° C. for 15 months. The at least one supplement may include a combination of arginine and methionine. The food composition may be formulated as a dry kibble, a wet food, a treat, or a dietary supplement. The companion animal may be a cat.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A depicts a bar graph showing average respiratory quotient values for cats across three dietary treatments, according to some aspects of the current disclosure.

FIG. 1B depicts a bar graph showing average energy expenditure per hour for cats across three dietary treatments, according to some aspects of the current disclosure.

FIG. 1C depicts a bar graph showing average energy expenditure corrected for metabolic body weight for cats across three dietary treatments, according to some aspects of the current disclosure.

FIG. 1D depicts a bar graph showing average thermal energy expenditure per day for cats across three dietary treatments, according to some aspects of the current disclosure.

FIG. 2A depicts a bar graph showing urine creatinine concentrations for cats across three dietary treatments, according to some aspects of the current disclosure.

FIG. 2B depicts a bar graph showing urine creatine concentrations for cats across three dietary treatments, according to some aspects of the current disclosure.

FIG. 2C depicts a bar graph showing urine creatine to creatinine ratios for cats across three dietary treatments, according to some aspects of the current disclosure.

FIG. 3A depicts a bar graph showing plasma arginine concentrations for cats across three dietary treatments, according to some aspects of the current disclosure.

FIG. 3B depicts a bar graph showing urine arginine concentrations for cats across three dietary treatments, according to some aspects of the current disclosure.

FIG. 4A depicts a bar graph showing plasma methionine concentrations for cats across three dietary treatments, according to some aspects of the current disclosure.

FIG. 4B depicts a bar graph showing urine methionine concentrations for cats across three dietary treatments, according to some aspects of the current disclosure.

FIG. 5A depicts a bar graph showing plasma glycine concentrations for cats across three dietary treatments, according to some aspects of the current disclosure.

FIG. 5B depicts a bar graph showing urine glycine concentrations for cats across three dietary treatments, according to some aspects of the current disclosure.

FIG. 6A depicts a bar graph showing plasma serine concentrations for cats across three dietary treatments, according to some aspects of the current disclosure.

FIG. 6B depicts a bar graph showing urine serine concentrations for cats across three dietary treatments, according to some aspects of the current disclosure.

FIG. 7A depicts a bar graph showing plasma leucine concentrations for cats across three dietary treatments, according to some aspects of the current disclosure.

FIG. 7B depicts a bar graph showing plasma isoleucine concentrations for cats across three dietary treatments, according to some aspects of the current disclosure.

FIG. 7C depicts a bar graph showing plasma valine concentrations for cats across three dietary treatments, according to some aspects of the current disclosure.

FIG. 7D depicts a bar graph showing urine leucine concentrations for cats across three dietary treatments, according to some aspects of the current disclosure.

FIG. 7E depicts a bar graph showing urine isoleucine concentrations for cats across three dietary treatments, according to some aspects of the current disclosure.

FIG. 7F depicts a bar graph showing urine valine concentrations for cats across three dietary treatments, according to some aspects of the current disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to food compositions and supplements for promoting metabolic and cognitive health in companion animals, including cats. Such food compositions may include one or more supplements selected from creatine, guanidinoacetate (GAA), arginine, methionine, and combinations thereof. GAA is a precursor compound to creatine that is synthesized from glycine and arginine in the liver and kidney of mammals.

The food compositions described herein may include one or more of creatine, GAA, arginine, and methionine at a concentration of at least 0.001% by weight of the food composition. In some cases, the food compositions may include one or more of creatine, GAA, arginine, and methionine at a concentration from about 0.001% to about 1% by weight of the food composition. In some cases, the food compositions may include one or more of creatine, GAA, arginine, and methionine at a concentration from about 0.0001% to about 2% by weight of the food composition. In some cases, the food compositions may include one or more of creatine, GAA, arginine, and methionine at a concentration from about 0.0001% to about 0.0005%, from about 0.0005% to about 0.001%, from about 0.001% to about 0.002%, from about 0.001% to about 0.005%, from about 0.001% to about 0.01%, from about 0.005% to about 0.01%, from about 0.01% to about 0.05%, from about 0.05% to about 0.1%, from about 0.1% to about 0.5%, from about 0.5% to about 1%, from about 0.15% to about 2%, and from about 1% to about 2% by weight of the food composition.

The supplements may be provided in dosing ranges from about 10 mg to about 400 mg per kg of body weight of the companion animal. In some cases, the dosing range may be adjusted based on the species, age, weight, and health status of the companion animal receiving the food composition.

Creatine is a non-proteinogenic amino acid derivative that plays a role in energy metabolism through the creatine kinase/phosphocreatine system. The creatine kinase/phosphocreatine system provides rapid buffering of adenosine triphosphate (ATP) levels during periods of high and fluctuating energy demand. Creatine is abundant in tissues with high and intermittent energy fluctuations, with approximately 98% of creatine being located in skeletal muscle, and the remainder being located in the heart and brain.

GAA is the immediate precursor to creatine in the endogenous creatine synthesis pathway. Once GAA is synthesized from glycine and arginine, GAA is subsequently methylated by S-adenosylmethionine (SAM) to form creatine. Supplementation with GAA may result in increased muscle creatine concentrations compared to supplementation with creatine directly. The stability of GAA during extrusion processing and storage of pet foods makes GAA a suitable alternative to creatine supplementation in dry and wet pet food formulations.

Arginine is an amino acid that serves as a precursor in the synthesis of GAA and is involved in multiple physiological processes including the urea cycle, nitric oxide production, protein synthesis, immune function, and wound healing. Companion animals, and cats in particular, may have limited capacity for endogenous arginine synthesis and may have higher requirements for dietary arginine compared to omnivorous monogastric species.

Methionine is an amino acid that serves as a precursor to SAM, which provides methyl groups for the conversion of GAA to creatine. Methionine is often one of the first limiting amino acids in commercial pet foods formulated with animal tissues and plant protein sources. Supplementation with creatine or GAA may reduce the metabolic demand for endogenous creatine synthesis, thereby sparing methionine and SAM methyl groups for other methylation reactions and physiological functions.

The food compositions and supplements described herein may be administered to companion animals including cats, horses, rabbits, ferrets, guinea pigs, and other small mammals. Such companion animals may be referred to as pets or domesticated animals. The food compositions and supplements described herein may promote various health outcomes in companion animals. Such health outcomes may include improvements in muscle composition, exercise performance, muscle recovery, energy expenditure, lean body mass, cardiac health, cognition, and reduced inflammation. The specific health outcomes observed may vary based on the species of companion animal, the specific supplement or combination of supplements administered, the dosing regimen, and the duration of supplementation.

Creatine is a compound wherein approximately 98% of total body creatine may be stored in skeletal muscle tissue, with the remainder distributed in the heart and brain. Creatine in muscle tissue may exist as free creatine or phosphocreatine, wherein phosphocreatine serves as a high-energy phosphate reservoir that may rapidly regenerate ATP from ADP during periods of increased energy demand. Creatine may undergo continuous non-enzymatic conversion to creatinine at a rate of approximately 1% to 2% of the total body creatine pool per day, wherein creatinine is released into the bloodstream and subsequently excreted in urine. The rate of creatinine excretion may be used as an indicator of muscle mass and creatine pool size in companion animals.

Due to the continuous conversion of creatine to creatinine, the total body creatine pool may be replenished daily through dietary intake or endogenous synthesis from the amino acid precursors glycine, arginine, and methionine. Endogenous creatine synthesis may involve a two-step enzymatic process wherein arginine: glycine amidinotransferase (AGAT) catalyzes the production of GAA and ornithine from arginine and glycine in the kidney and pancreas, and guanidinoacetate N-methyltransferase (GAMT) catalyzes the transfer of a methyl group from SAM to GAA to produce creatine in the liver. The production of creatine through endogenous synthesis may consume approximately 75% of total SAM methyl group utilization. Dietary creatine supplementation may reduce the metabolic demand for endogenous creatine synthesis, thereby sparing arginine for protein synthesis, urea cycle function, nitric oxide production, immune function, and wound healing, and sparing methionine and SAM methyl groups for other methylation reactions including DNA methylation, protein methylation, and phospholipid synthesis.

Creatine supplementation may provide nutritional benefits related to muscle composition, exercise performance, and muscle recovery in companion animals. Increased creatine availability may enhance the phosphocreatine pool in muscle tissue, thereby supporting increased ATP regeneration capacity during muscle contraction, which may support increased muscle protein synthesis and muscle fiber hypertrophy. The creatine kinase/phosphocreatine system may provide rapid ATP regeneration during short bursts of high-intensity exercise lasting from a few seconds to approximately 30 seconds, wherein enhanced phosphocreatine availability may support improved performance in activities requiring strength, power, agility, and jumping ability. Creatine supplementation may increase muscle mass, muscle strength, isometric force production, isokinetic force production, and muscular endurance in companion animals of various ages and activity levels. In aging companion animals, creatine supplementation may counteract sarcopenia by supporting muscle protein synthesis and reducing muscle protein breakdown. Creatine may reduce exercise-induced muscle damage by supporting cellular energy homeostasis during and after exercise, may reduce post-exercise inflammation and muscle soreness, and may reduce lactic acid accumulation during anaerobic exercise by reducing reliance on anaerobic glycolysis, thereby increasing exercise capacity and reducing recovery time between exercise bouts.

Creatine supplementation may provide nutritional benefits related to lean body mass, energy expenditure, and cardiac health in companion animals. Creatine may promote increases in lean body mass through enhanced muscle protein synthesis and reduced muscle protein breakdown, while reducing body fat percentage by supporting increased energy expenditure and fatty acid oxidation. The creatine kinase/phosphocreatine system may support increased energy expenditure by providing rapid ATP regeneration during periods of increased metabolic demand, and creatine supplementation may promote a shift in substrate utilization toward fatty acid oxidation, as indicated by reduced respiratory quotient values during indirect calorimetry measurements. Creatine is present in cardiac tissue and may support energy metabolism in the heart through the creatine kinase/phosphocreatine system, wherein the system may provide rapid ATP buffering to support cardiac contractile function in companion animals with increased cardiac demands due to exercise, aging, or cardiac conditions.

Creatine supplementation may provide nutritional benefits related to cognition and inflammation reduction in companion animals. Creatine is present in brain tissue and may support neuronal energy metabolism through the creatine kinase/phosphocreatine system, wherein creatine supplementation may improve memory, attention, processing speed, and reasoning ability, may enhance cognitive performance under conditions of stress or mental fatigue by supporting neuronal ATP availability, and may delay age-related cognitive decline by supporting neuronal energy homeostasis and reducing oxidative stress. Creatine may reduce inflammatory responses through various mechanisms including modulation of inflammatory cytokine production and reduction of oxidative stress, and may reduce chronic low-grade inflammation associated with aging, obesity, and metabolic diseases in companion animals, wherein reduced inflammation may support overall health and well-being in companion animals receiving creatine supplementation.

GAA may serve as an alternative supplement to creatine in food compositions for companion animals due to cost and stability considerations. GAA may be synthesized from glycine and arginine in the liver and kidney through the action of the enzyme arginine: glycine amidinotransferase, and as a precursor compound to creatine, GAA may be converted to creatine through methylation by SAM in the liver. The stability of GAA during extrusion processing and storage of pet foods may provide an advantage over creatine supplementation, as GAA may exhibit losses of less than 1% post-extrusion and less than 10% after storage at 25° C. for 15 months, whereas creatine may exhibit losses of approximately 15% post-extrusion and approximately 63% after equivalent storage conditions. When GAA is provided as a supplement in food compositions, the conversion of GAA to creatine may require adequate availability of methyl groups from SAM, wherein the methylation of GAA to creatine by the enzyme guanidinoacetate N-methyltransferase consumes SAM methyl groups derived from methionine through the methionine cycle. In some cases, the method of promoting wellbeing in companion animals may include supplementation with excess methionine when GAA is provided to support creatine synthesis, wherein the provision of excess methionine may ensure adequate SAM methyl group availability for the conversion of supplemental GAA to creatine and may prevent methionine availability from becoming a limiting factor in creatine synthesis from the supplemented GAA.

Supplementation with GAA may result in an arginine sparing effect in companion animals, wherein exogenous GAA introduced through dietary supplementation may reduce the channeling of arginine into GAA synthesis through the arginine: glycine amidinotransferase reaction, thereby making arginine available to support other physiological functions. The arginine sparing effect of GAA supplementation may support multiple physiological processes including protein synthesis by providing arginine as a substrate for incorporation into newly synthesized proteins, urea cycle function by providing arginine as a substrate for the enzyme arginase, nitric oxide production by providing arginine as a substrate for nitric oxide synthase enzymes, immune system function through arginine-dependent immune cell proliferation, and wound healing by providing arginine for collagen synthesis and tissue repair processes. The arginine sparing effect may be particularly relevant in cats, wherein cats may produce arginine endogenously in limited amounts due to low activities of enzymes involved in arginine synthesis, may have greater arginine requirements compared to omnivorous monogastric species due to increased activity of aminotransferase enzymes and elevated levels of ureagenesis at baseline, and may have a urea cycle that is not downregulated during periods of fasting or after consuming low-protein diets, resulting in a continuous demand for arginine to support urea cycle function.

GAA may undergo methylation by SAM to form creatine through the action of the enzyme guanidinoacetate N-methyltransferase (GAMT) in the liver, wherein the methylation reaction transfers a methyl group from SAM to the guanidino nitrogen of GAA, producing creatine and S-adenosylhomocysteine as products, and once creatine is synthesized or absorbed from dietary sources, creatine may be transported to tissues with high energy demands including skeletal muscle, cardiac muscle, and brain tissue. In muscle tissue, creatine may combine with a phosphate group to form phosphocreatine (PCr) through the action of the enzyme creatine kinase during periods of rest or low energy demand when ATP concentrations are elevated, wherein PCr may serve as a high-energy phosphate reservoir that stores energy in the form of a phosphocreatine bond. During periods of high energy demand such as during exercise or muscle contraction, PCr may be broken down to release creatine and inorganic phosphate, wherein the phosphate group released from PCr may be transferred to adenosine diphosphate (ADP) to regenerate ATP through the reverse creatine kinase reaction, providing the fastest mechanism for ATP regeneration among the biochemical pathways available for ATP synthesis. Energy expenditure (EE) refers to the total amount of energy expended by an organism over a given period of time and may be measured through indirect calorimetry, wherein creatine supplementation may improve EE in companion animals by supporting increased ATP turnover through the creatine kinase/PCr system, and GAA supplementation may similarly improve EE by increasing muscle creatine concentrations following conversion of GAA to creatine through the GAMT reaction. Creatine and GAA supplementation may reduce body fat percentage in companion animals by supporting increased fatty acid oxidation as indicated by reduced respiratory quotient values, may increase lean muscle mass by supporting muscle protein synthesis and reducing muscle protein breakdown through enhanced ATP availability, and may be particularly relevant in companion animals that are overweight or obese wherein approximately 40% of the feline population may be classified as overweight or obese. The supplements described herein may be provided in bioavailable forms that are absorbed in the gastrointestinal tract of companion animals, wherein GAA may be formulated to be readily converted into creatine once ingested, transported to the liver following absorption, and methylated by SAM through the action of GAMT to form creatine for subsequent uptake into muscle tissue and other tissues with high energy demands.

The food compositions described herein may be formulated for particular animal types, breeds, sizes, and physiological needs. Formulations for cats may differ from formulations for other species based on differences in metabolic rates, nutritional requirements, and physiological characteristics between the two species. Cats may have higher requirements for certain amino acids including arginine and taurine compared to dogs, and formulations for cats may be adjusted to account for these species-specific nutritional requirements.

Formulations for senior companion animals may be adjusted to support age-related changes in metabolism, muscle mass, and cognitive function. Senior cats may experience sarcopenia, which is characterized by progressive loss of muscle mass and strength with advancing age. Formulations for senior companion animals may include supplements at concentrations designed to counteract age-related muscle loss and support cognitive function during the aging process.

Formulations for companion animals with specific health conditions may be adjusted based on the physiological needs associated with those conditions. Companion animals that are overweight or obese may benefit from formulations designed to support increased energy expenditure and fatty acid oxidation while preserving lean muscle mass. Companion animals with increased inflammatory conditions may benefit from formulations containing supplements at concentrations designed to support reduced inflammatory responses.

Species-specific dosages may account for varying metabolic rates between cats and other companion animals. Cats may have different creatine turnover rates and pool sizes compared to other companion animals, and supplement dosages may be adjusted to account for these species-specific differences in creatine metabolism. The dosing range of supplements from about 10 mg to about 400 mg per kg of body weight may be adjusted within this range based on the species, with cats potentially receiving different doses per unit body weight from other companion animals to achieve comparable physiological effects.

Formulations may be adjusted based on the activity level and lifestyle of the companion animal. Companion animals with sedentary lifestyles may receive formulations with lower supplement concentrations compared to companion animals engaged in regular physical activity.

Formulations for kittens may be adjusted to support growth and development during early life stages. Young companion animals may have increased requirements for amino acids and other nutrients to support rapid tissue growth and development. Formulations for young companion animals may include supplements at concentrations designed to support muscle development, skeletal growth, and cognitive development during critical developmental periods.

Formulations for pregnant or lactating companion animals may be adjusted to support the increased nutritional demands associated with reproduction. Pregnant and lactating cats may have elevated requirements for amino acids, energy, and other nutrients to support fetal development and milk production. Formulations for reproductive companion animals may include supplements at concentrations designed to meet the elevated metabolic demands of pregnancy and lactation while supporting maternal health.

The food compositions described herein may be formulated as dry food compositions, wet food compositions, or dietary supplements in various forms. Dry food compositions may include kibble, biscuits, and other extruded or baked products that have been processed to reduce moisture content. Wet food compositions may include gravies, meat purees, vegetable purees, and other products with higher moisture content compared to dry food compositions. Dietary supplements may be administered as chewable gummies, tablets, or other dosage forms separate from the primary diet of the companion animal.

Dry food compositions may be produced through extrusion processing, wherein ingredients are mixed, heated, and forced through a die to form shaped pieces. Kibble may be produced in various shapes and sizes suitable for different companion animal species and breed sizes.

Biscuits may be produced through baking processes and may serve as treats or supplemental food items for companion animals. Biscuits may also be produced through an extrusion process, wherein ingredients may be mixed, heated, and forced through a die to form shaped pieces that may subsequently be dried or baked to achieve desired texture and moisture content. The extrusion process may allow for incorporation of supplements including creatine, GAA, arginine, and methionine into biscuit formulations while maintaining supplement stability during processing.

The stability of supplements during extrusion processing may influence the selection of supplements for inclusion in dry food compositions. GAA may exhibit greater stability during extrusion processing compared to creatine, with GAA exhibiting losses of less than 1% post-extrusion whereas creatine may exhibit losses of approximately 15% post-extrusion. The selection of GAA as a supplement in dry food compositions may provide advantages in terms of supplement retention during manufacturing processes.

The stability of supplements during storage may influence the selection of supplements for inclusion in dry food compositions. Dry food compositions may be stored for extended periods prior to consumption by companion animals, and supplement stability during storage may affect the nutritional value of the food composition at the time of consumption. GAA may exhibit losses of less than 10% after storage at 25° C. for 15 months, whereas creatine may exhibit losses of approximately 63% after equivalent storage conditions. The selection of GAA as a supplement in dry food compositions may provide advantages in terms of supplement retention during storage periods.

The food compositions described herein may be produced through processing methods that utilize lower temperatures while still providing microbial protection. Retort processing may be employed for wet food compositions, wherein the food composition may be sealed in containers and subjected to heat treatment at temperatures sufficient to achieve commercial sterility while minimizing thermal degradation of supplements. High-pressure processing may be utilized as an alternative or complementary method to thermal processing, wherein the food composition may be subjected to elevated pressures that may inactivate microorganisms while preserving heat-sensitive supplements including creatine and GAA. The selection of processing parameters including temperature, pressure, and duration may be optimized to balance microbial safety requirements with supplement retention in the final food composition.

Freeze-dried food compositions may be produced through lyophilization processing, wherein the food composition may be frozen and subsequently subjected to reduced pressure conditions that cause frozen water to sublimate directly from solid to vapor phase without passing through a liquid phase. Freeze-drying may preserve the nutritional integrity of supplements including creatine, GAA, arginine, and methionine due to the low temperatures employed throughout the process, wherein the absence of high heat exposure may minimize thermal degradation of heat-sensitive compounds. Freeze-dried food compositions may be formulated as complete meals, treats, or meal toppers for companion animals, and may be rehydrated with water prior to feeding or may be served in dry form. The porous structure of freeze-dried food compositions may promote rapid rehydration and may enhance palatability for companion animals. Freeze-dried treats may provide a convenient delivery format for supplements, wherein the low-temperature processing may preserve supplement bioavailability while producing a lightweight, shelf-stable product with extended storage life.

Wet food compositions may include gravies, which are liquid or semi-liquid preparations that may be poured over dry food or served as standalone food items. Gravies may contain meat-based ingredients, vegetable-based ingredients, or combinations thereof. Supplements including creatine, GAA, arginine, and methionine may be incorporated into gravy formulations to provide nutritional benefits to companion animals consuming the wet food compositions.

Wet food compositions may include meat purees, which are preparations wherein meat ingredients have been processed to form a smooth, homogeneous consistency. Meat purees may be produced from various protein sources including poultry, beef, fish, and other animal-derived ingredients. Supplements may be incorporated into meat puree formulations during processing to provide uniform distribution of supplements throughout the wet food composition.

Wet food compositions may include vegetable purees, which are preparations wherein vegetable ingredients have been processed to form a smooth, homogeneous consistency. Vegetable purees may be produced from various plant-based ingredients and may be combined with meat-based ingredients to form complete food compositions for companion animals. Supplements may be incorporated into vegetable puree formulations to provide nutritional benefits in plant-based or mixed food compositions.

The food compositions described herein may be formulated for palatability to promote consumption by companion animals. Palatability refers to the acceptability and appeal of a food composition based on taste, texture, aroma, and other sensory characteristics. Enhanced palatability may promote consistent and complete consumption of supplements, thereby supporting the intended nutritional benefits.

In some cases, supplements may be administered as a slurry mixed with palatable food components to improve consumption. A slurry may be prepared by mixing the supplement with a liquid or semi-liquid food component to form a homogeneous mixture. The slurry may be mixed with lickable treats to improve palatability and promote consumption by companion animals. Lickable treats may include semi-liquid or paste-like food products that companion animals consume by licking. The mixing of supplements with lickable treats may mask any undesirable taste characteristics of the supplements and may encourage voluntary consumption by companion animals.

The formulation of supplements in palatable delivery forms may support compliance with supplementation regimens in companion animals. Companion animals may exhibit preferences for certain food textures, flavors, and aromas, and the formulation of supplements in preferred delivery forms may promote consistent consumption. The use of palatable delivery forms such as slurries mixed with lickable treats may be particularly useful for administering supplements to companion animals that are reluctant to consume supplements in other forms such as tablets, capsules, or powders.

Wet food compositions may provide advantages in terms of palatability for companion animals that prefer moist food textures. The higher moisture content of wet food compositions may support hydration in companion animals and may be particularly suitable for companion animals with reduced water intake or increased hydration requirements. Wet food compositions may be served as complete meals or may be mixed with dry food compositions to provide variety in texture and flavor.

The food compositions described herein may have varying shelf life characteristics depending on the formulation type and the supplements incorporated therein. Food compositions containing one or more of creatine, GAA, arginine, and methionine may exhibit different stability profiles during storage. Dry kibble products may have a shelf life of approximately 18 to 24 months, wherein the stability of the incorporated supplements during storage may support retention of supplement activity throughout the storage period. Wet food compositions produced through retort processing may have a shelf life of up to 48 months, wherein the hermetically sealed containers and commercial sterilization process may provide extended preservation of the food composition. Freeze-dried food compositions may exhibit extended shelf stability due to the low moisture content achieved through lyophilization processing. Among the supplements described herein, GAA may exhibit greater stability during processing and storage compared to creatine, wherein GAA may be more resistant to degradation during extrusion processing and may retain greater potency throughout extended storage periods. In some embodiments, guanidinoacetate may exhibit losses of less than 1% post-extrusion and less than 10% after storage at 25° C. for 15 months.

Dietary supplements may be administered as chewable gummies, which are soft, chewy dosage forms that may be flavored to improve palatability for companion animals. Chewable gummies may be formulated to contain creatine, GAA, arginine, methionine, or combinations thereof at specified concentrations per gummy unit. The chewable texture of gummies may promote voluntary consumption by companion animals and may facilitate accurate dosing of supplements.

Dietary supplements may be administered as tablets, which are solid dosage forms produced through compression of powdered ingredients. Tablets may be formulated to contain creatine, GAA, arginine, methionine, or combinations thereof at specified concentrations per tablet unit. Tablets may be administered directly to companion animals or may be crushed and mixed with food to facilitate consumption. Tablets may be coated with palatable coatings to improve acceptance by companion animals.

Dietary supplements in the form of chewable gummies or tablets may be administered separately from the primary diet of the companion animal. Separate administration of dietary supplements may allow for precise control of supplement dosing independent of food intake. Dietary supplements may be administered at specific times relative to meals or physical activity to support intended physiological effects. The administration of dietary supplements as chewable gummies or tablets may be particularly useful for companion animals receiving commercial diets that do not contain supplemental creatine, GAA, arginine, or methionine.

Dietary supplements may be administered as liquid supplements, which are fluid preparations that may be added to food or water or administered directly to companion animals using a dropper or syringe. Liquid supplements may be formulated to contain creatine, GAA, arginine, methionine, or combinations thereof in aqueous or oil-based carriers, wherein the liquid form may facilitate rapid absorption and may be particularly suitable for companion animals that have difficulty consuming solid dosage forms.

The selection of food composition type may be based on the preferences of the companion animal, the convenience for the caregiver, and the intended nutritional objectives. Dry food compositions may provide convenience in terms of storage, portion control, and feeding management. Wet food compositions may provide advantages in terms of palatability and hydration support. Dietary supplements in the form of chewable gummies or tablets may provide flexibility in supplementation independent of the primary diet composition.

### Examples

The following examples are provided to illustrate various aspects of the present disclosure and are not intended to limit the scope of the disclosure in any manner. The examples demonstrate food compositions and methods for promoting wellbeing in companion animals through supplementation with creatine (Cr), arginine (Arg), methionine (Met), and combinations thereof. Additional embodiments consistent with the foregoing description are encompassed within the scope of the present disclosure. Variations in supplement concentrations, dosing regimens, food composition formulations, companion animal species, and administration protocols may be implemented without departing from the principles described herein. The specific parameters, measurements, and outcomes presented in the examples are representative of particular experimental conditions and may vary based on factors including companion animal species, age, weight, health status, activity level, and duration of supplementation.

### Animals and Housing

Fourteen domestic shorthair male neutered adult cats (Marshall's Bio Resources, Waverly, NY) were enrolled in this trial. All cats were deemed healthy based on a physical exam, complete blood count, and serum biochemical profiles. Cats had a mean body weight (BW) of 4.66 kg (range: 4.1 kg-5.17 kg) and mean body condition score of 5.71 (range: 5-8) at the start of the trial.

Cats were housed indoors as a group in a free-living environment (23×19 ft) at the Animal Biosciences Cattery at the Ontario Agricultural College of the University of Guelph (Guelph, ON, Canada). Temperature and humidity in the room were maintained at 24.3±0.05° C. and 40.3±0.9%, respectively. The room was controlled with a 12 hour light 12 hour dark cycle, with the lights turning on at 0700 h and off at 1900 h. Distilled water was provided ad libitum, both as still water (in bowls) and flowing water (open tap and fountains).

### Diet

All cats were transitioned onto the same commercial extruded diet (ACANA Homestead Harvest, Champion Pet Foods Holdings Inc.) formulated for adult maintenance according to the Association of American Feed Control Officials (AAFCO), 4 weeks prior to the start of the trial (wash-in period) and for the duration of the study. Cats were fed to maintain BW based on historical colony feeding records. All cats were weighed, and body condition scored weekly during both the wash-in and treatment periods. The quantity of food was adjusted on an individual basis as needed to maintain initial body weight and ensure that hypotheses were evaluated under conditions of energy balance, as positive or negative energy balance would alter energetics and macronutrient utilization. Throughout both the adaptation and trial periods, cats were separated into individual cages once daily at 08:00 h for 1 h, in order to be fed individually.

### Study Design

The study was originally designed as a balanced 14×5 Latin rectangle, in which all cats (n=14) received each of the five dietary treatments for a 14-day period in a randomized order. The treatments included: (1) control (base kibble), (2) control+creatine (Cr; 200 mg/kg BW) (AlzChem, Trostberg, Germany), (3) control+Arg+Met (2× NRC RA Arg: 0.38 g/kg BW\hat{ }0.67; Met: 0.084 g/kg BW\hat{ }0.67). For the AA treatments, Arg and Met were supplemented at 2× the NRC recommended allowance.

Since Cr is hydrophobic, it was combined with a lickable treat (Catlt Creamy Lickable Treat; 2 mg/kg BW) and stirred into a slurry. To maintain consistency across all treatments, the lickable treat was provided with all dietary treatments, mixed with either Cr, Arg+Met, or nothing (control), in addition to the base kibble. Each cat was given 1 h to consume all of their food. Orts from each cat were measured and recorded daily. The 14 cats were separated into 4 groups (2 groups of 4, 2 groups of 3) and as such, groups were stagger started over 4 days due to there only being 4 calorimetry chambers. All groups were balanced for BW (mean BW for groups 1-4:4.75 kg, 4.56 kg, 4.56 kg, 4.76 kg). Each treatment was provided for a period of 2 weeks and all cats received all treatments in a randomized balanced order as per experimental design. On day 12, urine was collected and analyzed for Cr, CrN, and AA. On day 14 blood was collected and analyzed for Cr, CrN, and AA and 24 h indirect calorimetry was performed to measure EE and respiratory quotient (RQ).

### Urine Collection

Urine was collected on day 12 via free-catch into a sterile urine collection cup or using non-absorbent litter (KatKor®; Rein Vet Products, Utrecht, The Netherlands). Following collection, urine was centrifuged for clarification at 1500× rpm×5 min at room temperature. Following centrifugation, urine was aliquoted into microcentrifuge tubes and stored at −80° C. until analysis.

### Blood Collection

On day 14, following 24-h calorimetry, fasted blood samples were taken from each cat. Blood samples were collected via jugular or saphenous venipuncture suing a syringe (Becton Dickinson and Company, Franklin Lakes, NJ, USA). Whole blood was collected and immediately syringed into sodium heparin tubes and stored on ice until centrifugation. Samples were centrifuged within 30 minutes of collection at 1500×g×15 min at 4° C. Following centrifugation, plasma was separated and stored at −80° C. until analysis.

### Urinary and Fasted Plasma Amino Acid Analysis

Free AA concentrations in plasma and urine were analyzed using ultra-performance liquid chromatography (UPLC) (adapted from Bidlingmeyer et al., 1984; Waters Corporation, Milford, MA). Briefly, 100 L of 10% sulfosalicylic acid (Sigma-Aldrich, St. Louis, MO) was used to deproteinate 100 μL of biological sample. Deproteinized samples were derivatized by an AccQ-Tag Ultra derivatization kit (Waters Corporation). The derivatized AAs (1 μL injection) were separated in an AccQ-Tag Ultra RP Column (2.1×100 mm, 1.7 UM; Waters Corporation) that was maintained at 55° C. using UPLC with UV detection (260 nm). AA peak areas were compared with known standards and analyzed with Waters Empower 2 Software (Waters Corporation). All urine samples were diluted by a factor of 10 prior to analysis and AA concentrations were corrected for urine CrN concentrations.

### Urine and Fasted Plasma Creatine and Creatinine Analysis

All frozen urine and plasma samples were transported on dry ice from the University of Guelph to McMaster University and stored at −80° C. in MRCMS. The sample pre-processing protocol is as follows: sample was vortex at 3000 RPM, an aliquot of 100 μL urine sample or 50 μL plasma sample, 100 μL of internal standard (15N-Histidine at 4 mM) and 200 μL acetonitrile were added to a 1.5 mL glass vial. The mixture was vortexed at 3000 RPM for 1 min. Subsequently, the mixture was centrifuged at 4500 RPM at 4° C. for 15 min. The resulting supernatant was diluted a 10-fold (100 μL of sample mixture+200 μL H₂O and 700 μL ACN). Due to high level of CrN in the samples relative to other metabolites of interest, the urine samples were further diluted 1000-fold for CrN analysis. All samples were analyzed using ultraperformance liquid chromatography (Agilent UPLC 1290 infinity II series) coupled with quadrupole time-of-flight mass spectrometer (Agilent iFunnel Q-TOF 6550). The column (Poroshell 120 HILIC) dimensions are 2.1×100 mm, 1.9 μm. The mobile phase of A consists of 20 mM ammonium formate in water and B consists of 20 mM ammonium formate in acetonitrile, the adjusted pH to 3.0 with formic acid. Flow rate of 0.6 ml/min and the column temperature is 30° C. Data acquisition was performed using Agilent MassHunter Workstation LC/MS Data Acquisition Software version B.06.01 while all data processing was performed using MassHunter Qualitative Analysis Software version B.07.00.

### Indirect Calorimetry

On the last day of each 2-week period, indirect calorimetry was performed to assess EE and RQ. Each calorimetry session lasted 24 hours. The indirect calorimetry system used was an open circuit, ventilated calorimeter with room air being drawn from each chamber at a rate of 3.9-5.1 L/min, depending on the cat. The exiting chamber air was dried by passing it through cylinders of calcium sulfate anhydrous (Drierite, W.A. Hammond Drierite Company LTD, Xenia, OH) and magnesium perchlorate (Fisher Scientific, Whitby, ON) before reaching the O2 and CO2 analyzers (Qubit Systems Inc., Kingston, ON). Prior to each session, calibration of the gas analysers and mass flow meters was performed using two standard gas mixtures (99.98% nitrogen and 1.01% carbon dioxide; Praxair, Guelph, ON, Canada). The system was re-calibrated during the sessions whenever a drift of more than 1% was observed. Respiratory gases were measured for 5 min every 25 min. Measurements were collected fasted (pre-prandial) (1.5 h prior to meal) and after a meal through the fed and extended postprandial states (22 h). The calorimetry chambers were plexiglass with the following dimensions: length×width×height: 146×60×89 cm. Cats were fed 100% of their daily ration and supplement after 3 fasted measures were completed. All cats had access to a litter box, a water bowl, and a blanket within the chamber. Water was filled as needed. Finally, RQ was calculated within the C950 Multi Channel Gas Exchange Software (Qubit Systems Inc.) and EE was calculated from O₂ consumption and CO2 production using the abbreviated Weir (1949) equation and expressed on a per kg metabolic BW basis (BW 0.75).

$$EE ( kcal / h ) = ( 3.94 \times {VO}_{2} ) + ( 1.1 \times {VCO}_{2} )$$

Where VO₂ is the volume of oxygen consumed (L/min) and VCO₂ is the volume of carbon dioxide produced (L/min).

### Statistical Analysis

Blood and urine marker data as well as BW, food intake, and caloric intake were analyzed as repeated measures using PROC GLIMMIX in SAS Studio (v 9.4; SAS Institute Inc., Cary, NC) with cat and period treated as random effects. The effect of treatment was evaluated. Respiratory quotient, EE corrected for metabolic BW (kcal/Metkg) and total EE (kcal/day) was analyzed at fasted (1.5 h), and at various post-prandial states (0-4 h, 4-8 h, 8-12 h, 12-16 h, 16-20 h, and >20 h)). Data were analyzed as repeated measures using PROC GLIMMIX in SAS Studio where time was repeated with cat nested within treatment as the subject. In the statistical model, the effect of treatment, time, and treatment by time interaction were evaluated. For all outcomes, model assumptions were assessed through residual analysis and if assumptions were violated, a log-transformation was performed. Means were separated using the Tukey-Kramer adjustment and significance was declared at P≤0.05, while trends were declared at 0.05<P<0.10.

### Body Weight and Feed Intake

Body weight, feed intake, and caloric intake did not differ among treatments, across periods, or between groups (P>0.05). Group means by treatment for BW, feed intake, and metabolizable energy (calculated using the ACANA Homestead Harvest guaranteed analysis, AAFCO, and NRC methods) are provided in Table 1.

TABLE 1

| | Group 1 | Group 2 | Group 3 | Group 4 | | | |
|---|---|---|---|---|---|---|---|
| | (n = 4) | (n = 4) | (n = 3) | (n = 3) | SD | P(trt) | P(group) |
| Body weight (kg) | | | | | 0.4 | 0.9670 | 0.5266 |
| Control | 4.70 | 4.68 | 4.71 | 4.64 | | | |
| Creatine | 4.72 | 4.62 | 4.70 | 4.67 | | | |
| Arg + Met | 4.69 | 4.65 | 4.69 | 4.68 | | | |
| Feed intake (g) | | | | | 4.3 | 0.1157 | 0.6765 |
| Control | 49.51 | 49.14 | 51.85 | 51.93 | | | |
| Creatine | 50.57 | 49.61 | 52.48 | 52.47 | | | |
| Arg + Met | 50.39 | 49.98 | 52.63 | 50.94 | | | |
| Calorie intake | | | | | 16.3 | 0.0520 | 0.6925 |
| (ME_{GA}), kcal/d | | | | | | | |
| Control | 186.08 | 182.32 | 194.11 | 190.32 | | | |
| Creatine | 188.66 | 185.61 | 197.22 | 198.42 | | | |
| Arg + Met | 185.89 | 188.70 | 197.97 | 188.70 | | | |
| Calorie intake | | | | | 15.3 | 0.0520 | 0.6925 |
| (ME_{AAFCO}), kcal/d^{#} | | | | | | | |
| Control | 174.70 | 171.17 | 182.23 | 178.67 | | | |
| Creatine | 177.12 | 174.26 | 185.16 | 186.28 | | | |
| Arg + Met | 174.52 | 177.03 | 185.86 | 177.16 | | | |
| Calorie intake | | | | | 16.2 | 0.0520 | 0.6925 |
| (ME_{NRC}), kcal/d^{%} | | | | | | | |
| Control | 184.64 | 180.92 | 192.61 | 188.85 | | | |
| Creatine | 187.21 | 184.18 | 195.70 | 196.89 | | | |
| Arg + Met | 184.45 | 187.11 | 196.44 | 187.25 | | | |

^{#}Calculated ME intake, according to the Modified Atwater equation, as required by the Association of American Feed Control Officials.
^{%}Calculated ME intake, according to the National Research using crude fiber.
Abbreviations: ME = metabolizable energy, SD = standard deviation, AAFCO = American Association of Feed Control Officials, NRC = National Research Council.

### Energy Expenditure (EE) and Respiratory Quotient

All EE and RQ data are presented in Table 2. There was no effect of treatment on EE expressed either per kg BW or per kg metabolic BW (P=0.1837 and P=0.2078, respectively). Similarly, there was no effect of treatment on RQ, although RQ tended to be lower in the Cr group compared to the control (P=0.0897). In contrast, RQ values differed significantly across time points (P<0.0001) as expected due to the response to meal feeding. The highest RQ values were observed at 8-12 h and 12-16 h, which were higher than estimates at fasting and between 0-4 h. Additionally, RQ estimates between 16-20 h were higher than 0-4 h. EE also differed across time (P<0.0001), with values higher at 0-4 h compared to fasting, and higher at 8-12 h compared to 12-16 h. No differences were observed in the secondary analysis (P≥0.05).

TABLE 2

| | Treatment | | | |
|---|---|---|---|---|
| | Control | Creatine | Arg + Met | |
| | (n = 13) | (n = 13) | (n = 14) | P(trt) |
| EE (kcal/kg BW) | 37.8 ± 1.99 | 37.6 ± 1.98 | 39.3 ± 1.98 | 0.1837 |
| EE (kcal/Met BW kg) | 62.9 ± 3.29 | 62.5 ± 3.27 | 65.1 ± 3.27 | 0.2078 |
| RQ | 0.829 ± 0.00693** | 0.818 ± 0.00683* | 0.823 ± 0.00685 | 0.0897 |

^{A,B}Different letters within the same row indicate statistical significance (P < 0.05);
*Indicate trends (0.05 < P < 0.10). Abbreviations: EE = energy expenditure, RQ = respiratory quotient, SEM = standard error of the mean, Met BW kg = metabolic body weight, trt = treatment.

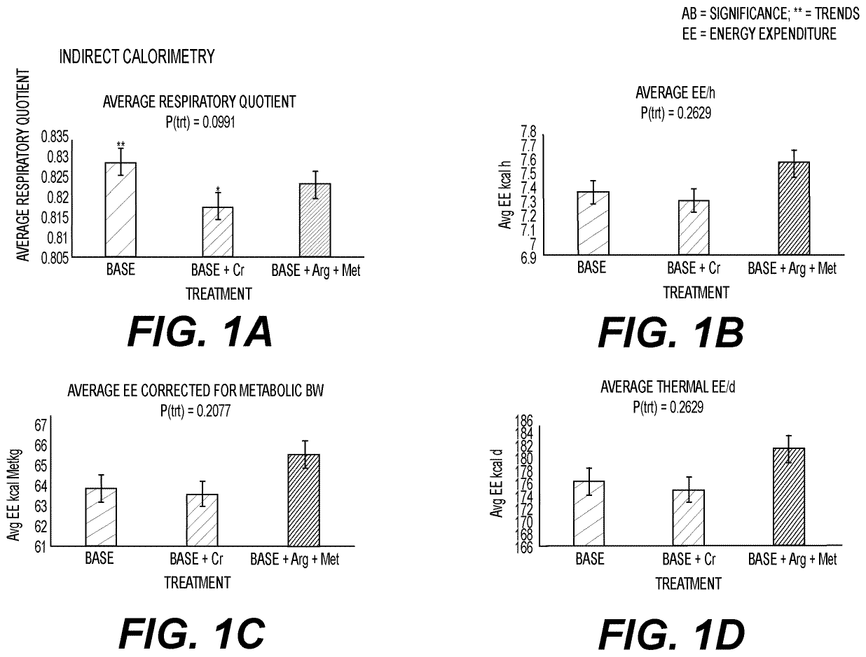

Referring to FIGS. 1A-1D, indirect calorimetry data from the dietary supplementation study in cats is presented across four panels showing respiratory quotient (RQ) and energy expenditure (EE) measurements for the three dietary treatments. FIGS. 1A-1D depict bar graphs comparing the base diet (BASE), the base diet supplemented with creatine (BASE+Cr), and the base diet supplemented with arginine plus methionine (BASE+Arg+Met) across multiple metabolic parameters.

FIG. 1A shows average respiratory quotient (RQ) values for the three dietary treatments with a treatment p-value of 0.0991. The BASE treatment displayed the highest average respiratory quotient value at approximately 0.833. The BASE+Cr treatment showed the lowest average respiratory quotient value at approximately 0.818. The BASE+Arg+Met treatment displayed an intermediate average respiratory quotient value at approximately 0.824. The trend toward lower respiratory quotient values in cats receiving the creatine-supplemented diet compared to the control diet suggests a metabolic shift toward fatty acid oxidation and gluconeogenesis. The observed trend in respiratory quotient values, while not reaching statistical significance at the p<0.05 level, may indicate that creatine supplementation promotes increased fatty acid oxidation in cats.

FIG. 1B shows average energy expenditure per hour measured in kilocalories for the three dietary treatments with a treatment p-value of 0.2629. No statistically significant differences were observed among the three dietary treatments for average energy expenditure per hour.

FIG. 1C shows average energy expenditure corrected for metabolic body weight measured in kilocalories per metabolic kilogram for the three dietary treatments with a treatment p-value of 0.2077. No statistically significant differences were observed among the three dietary treatments for average energy expenditure corrected for metabolic body weight.

FIG. 1D shows average thermal energy expenditure per day measured in kilocalories for the three dietary treatments with a treatment p-value of 0.2629. No statistically significant differences were observed among the three dietary treatments for average thermal energy expenditure per day.

The indirect calorimetry results presented in FIGS. 1A-1D demonstrate that while energy expenditure parameters did not differ significantly among the three dietary treatments, the trend toward reduced respiratory quotient values in cats receiving creatine supplementation may indicate a shift in substrate utilization. The reduced respiratory quotient values observed in the creatine-supplemented group may reflect increased reliance on fatty acid oxidation as an energy substrate compared to carbohydrate oxidation. Such a metabolic shift toward fatty acid oxidation may support body composition improvements by promoting the utilization of stored lipids for energy production.

### Plasma and Urine Creatine, Creatinine, and Creatine: Creatinine Concentrations

As shown in Table 3A, plasma Cr and Cr: CrN concentrations were greater (P<0.0001, P<0.0001, respectively) in the Cr group compared to the control and Arg+Met groups. Plasma CrN was greater in the Cr group compared to the control group (P=0.0048) and tended to be greater in the Cr group compared to the Arg+Met group (P<0.10).

TABLE 3A

| | Treatment | | | | |
|---|---|---|---|---|---|
| | Control | Creatine | Arg + Met | | |
| ng/mL | (n = 13) | (n = 14) | (n = 14) | SEM | P(trt) |
| Creatine | 5.74 (5.26- | 14.1 (11.0- | 6.00 (5.38- | 0.651 | <0.0001 |
| | 6.61)^{B} | 17.6)^{A} | 7.17)^{B} | | |
| Creatinine | 163 (130- | 189 (159- | 173 (128- | 3.89 | 0.0048 |
| | 195)^{B} | 227)^{A}** | 211)^{AB}* | | |
| Cr:CrN | 0.0360 | 0.0755 | 0.0353 | 0.0033 | <0.0001 |
| | (0.0295- | (0.0554- | (0.0282- | | |
| | 0.0508)^{B} | 0.0964)^{A} | 0.0445)^{B} | | |

^{#}Due to adverse reactions observed in the majority of cats consuming GAA-containing diets, this analysis includes only cats that consumed the GAA treatments.
^{A,B}Different letters within the same row indicate statistical significance (P < 0.05);
*Indicate trends (0.05 < P < 0.10)
Abbreviations: SEM = standard error of the mean, trt = treatment.

Table 3B shows urine Cr, CrN, and Cr: CrN concentrations were greater (P<0.0001, P=0.0006, P<0.0001, respectively) in the Cr group compared to those in the control and Arg+Met groups.

TABLE 3B

| | Treatment | | | | |
|---|---|---|---|---|---|
| | Control | Creatine | Arg + Met | | |
| ng/mL | (n = 13) | (n = 14) | (n = 14) | SEM | P(trt) |
| Creatine | 80899 | 1886750 | 72286 | 78682 | <0.0001 |
| | (6127.3- | (172110.6- | (5680.0- | | |
| | 169137)^{B} | 4037387)^{A} | 163943)^{B} | | |
| Creatinine | 5086180 | 5654665 | 4808692 | 139614.3 | 0.0006 |
| | (288757.1- | (924591.2- | (211448.4- | | |
| | 9047844)^{B} | 9952172)^{A} | 10282695)^{B} | | |
| Cr:CrN | 0.0170 | 0.341 | 0.0167 | 0.0140 | <0.0001 |
| | (0.00333- | (0.0291- | (0.00428- | | |
| | 0.0333)^{B} | 0.628)^{A} | 0.0317)^{B} | | |

^{†}A total of 4 samples per cat per treatment were taken over the last 4 days of each period. All samples were included in the analyses to reduce variability.
^{A,B}Different letters within the same row indicate statistical significance (P < 0.05);
*Indicate trends (0.05 < P < 0.10)
Abbreviations: SEM = standard error of the mean, trt = treatment.

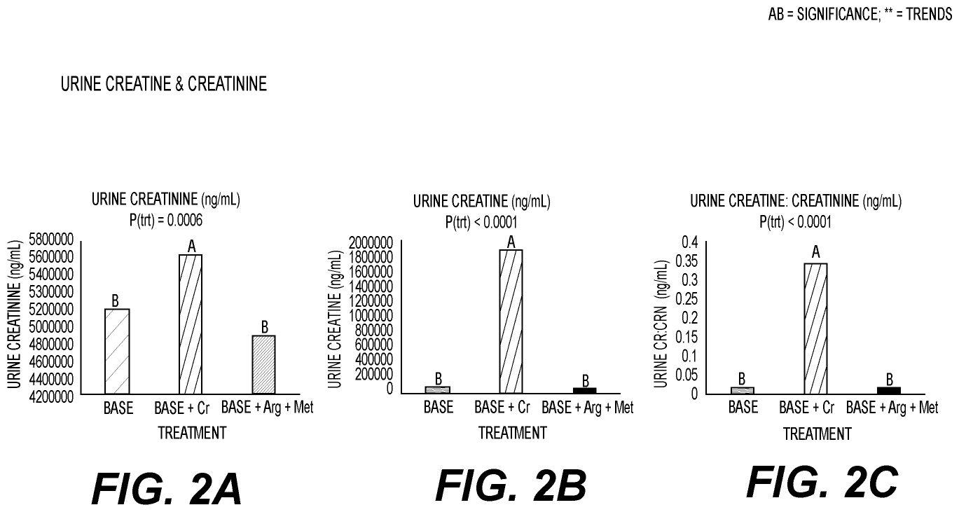

Referring to FIGS. 2A-2C, urine creatine and creatinine measurements from the dietary supplementation study in cats are presented across three panels showing creatinine concentration, creatine concentration, and the creatine to creatinine ratio for the three dietary treatments. FIG. 2A depicts urine creatinine concentrations measured in nanograms per milliliter, wherein the BASE+Cr treatment displayed a significantly higher creatinine concentration compared to the BASE and the BASE+Arg+Met treatment (P=0.0006). FIG. 2B depicts urine creatine concentrations measured in nanograms per milliliter, wherein the BASE+Cr treatment displayed a substantially elevated creatine concentration compared to both the BASE treatment and the BASE+Arg+Met treatment (P<0.0001). FIG. 2C depicts the urine creatine to creatinine ratio, wherein the BASE+Cr treatment displayed a higher ratio compared to ratios of both the BASE treatment and the BASE+Arg+Met treatment (P<0.0001) groups.

The urine creatine and creatinine results presented in FIGS. 2A-2C and Table 2B demonstrate that dietary creatine supplementation resulted in significantly higher urine creatine concentrations, urine creatinine concentrations, and urine creatine to creatinine ratios compared to both the base diet and the arginine plus methionine supplemented diet. The similar urine creatine and creatinine values observed between the base diet group and the arginine plus methionine supplemented group suggest that excess dietary arginine and methionine may not be preferentially utilized for endogenous creatine synthesis in cats. The data suggest that a direct source of creatine may be supplemented rather than the precursor amino acids arginine and methionine to effectively increase the body creatine pool in companion animals. The higherurine creatine and creatinine concentrations observed in cats receiving direct creatine supplementation reflect increased creatine availability and subsequent conversion to creatinine through the non-enzymatic dehydration reaction that occurs in muscle tissue.

### Fasted Plasma Amino Acids

All plasma AA concentrations are presented in Table 4A. Starting with the AA involved in Cr synthesis, plasma Arg was greatest in the Arg+Met group, followed by the Cr group, then the control (P<0.0001). Plasma Gly was greater in the control group compared to the Arg+Met group, while Cr was intermediate (P=0.0044). There were no differences in plasma Met (P=0.1203). The branched-chain AA, leucine, isoleucine, and valine were greater (P=0.0007; P=0.0035; P=0.0154, respectively) in the Arg+Met group and control group compared to the Cr group. Plasma serine was greater in the control and Cr groups compared to the Arg+Met group (P<0.0001) and tended to be greater in the Cr group compared to the control group (P=0.0649). Alanine was greater in the control and Arg+Met group compared to the Cr group (P=0.0229). Asparagine was greater in the control group compared to the Arg+Met group, while Cr was intermediate (P=0.0380). Proline was greater in the control group compared to the Cr group, while Arg+Met was intermediate (P=0.0231). No differences were observed among treatment groups for plasma aspartic acid, cystine, glutamate, glutamine, histidine, lysine, phenylalanine, taurine, threonine, tryptophan or tyrosine (P>0.05).

TABLE 4A

| | Treatment | | | |
|---|---|---|---|---|
| Amino Acids | Control | Creatine | Arg + Met | |
| (uM) | (n = 13) | (n = 13) | (n = 14) | P(trt) |
| Alanine | 577 ± 46.1^{A} | 502 ± 46.1^{B} | 580 ± 45.6^{A} | 0.0229 |
| Arginine | 163 ± 7.15^{C} | 180 ± 7.15^{B} | 213 ± 7.02^{A} | <0.0001 |
| Aspartic acid | 1.61 ± 0.423 | 0.850 ± 0.423 | 0.593 ± 0.407 | 0.2051 |
| Asparagine | 33.2 ± 1.43^{A} | 32.7 ± 1.43^{AB} | 31.3 ± 1.42^{B} | 0.0380 |
| Cystine | 37.9 ± 1.52 | 38.4 ± 1.52 | 37.4 ± 1.49 | 0.7189 |
| Glutamate | 31.9 ± 2.43 | 29.0 ± 2.43 | 27.5 ± 2.34 | 0.4130 |
| Glutamine | 422 ± 15.5 | 408 ± 15.5 | 414 ± 15.3 | 0.4762 |
| Glycine | 417 ± 15.8^{A} | 400 ± 15.6^{AB} | 379 ± 15.6^{B} | 0.0044 |
| Histidine | 134 ± 3.14 | 132 ± 3.15 | 133 ± 3.07 | 0.7997 |
| Isoleucine | 71.5 ± 3.60^{A} | 63.0 ± 3.60^{B} | 73.0 ± 3.54^{A} | 0.0035 |
| Leucine | 131 ± 5.98^{A} | 114 ± 5.98^{B} | 130 ± 5.90^{A} | 0.0007 |
| Lysine | 166 ± 7.23 | 160 ± 7.24 | 158 ± 7.14 | 0.2076 |
| Methionine | 43.9 ± 3.39 | 49.8 ± 3.41 | 44.5 ± 3.41 | 0.1203 |
| Phenylalanine | 89.5 ± 1.86 | 88.8 ± 1.86 | 89.0 ± 1.86 | 0.9187 |
| Proline | 183 ± 5.73^{A} | 171 ± 5.73^{B} | 174 ± 5.65^{AB} | 0.0231 |
| Serine | 192 ± 9.87^{A}* | 204 ± 9.87^{A}** | 169 ± 9.81^{B} | <0.0001 |
| Taurine | 175 ± 12.2 | 177 ± 12.2 | 144 ± 11.7 | 0.1126 |
| Threonine | 134 ± 6.25 | 125 ± 6.26 | 128 ± 6.15 | 0.2517 |
| Tryptophan | 70.6 ± 1.83 | 70.7 ± 1.83 | 72.3 ± 1.78 | 0.6075 |
| Tyrosine | 62.2 ± 2.25 | 60.9 ± 2.26 | 63.0 ± 2.20 | 0.6266 |
| Valine | 204 ± 9.48 | 184 ± 9.48 | 203 ± 9.35 | 0.0154 |

^{A,B}Different letters within the same row indicate statistical significance (P < 0.05);
*Indicate trends (0.05 < P < 0.10)
Abbreviations: SEM = standard error of the mean, trt = treatment.

### Urinary Amino Acids

All urine AA concentrations are presented in Table 4B. Urine Arg was greatest in the control group compared to the Cr group, with the Arg+Met group being intermediate (P=0.0425). Urine Met was higher in the Arg+Met group, compared to control and Cr groups, which did not differ (P<0.0001). Urinary Gly was lower in the Arg+Met group compared to the Cr group and tended to be lower in the Arg+Met group compared to the control group (P=0.0089). Glutamate was lower in the Cr and control groups compared to the Arg+Met group (P=0.0060). Glutamine tended to be greater in the Arg+Met group compared to the Cr group (P=0.0716). Taurine excretion was significantly greater in the control group compared to the Arg+Met group, while Cr was intermediate (P=0.0503). No significant differences were observed among groups for urine alanine, histidine, serine, lysine, cystine, aspartic acid, leucine, isoleucine, valine, proline, threonine, phenylalanine, tryptophan, tyrosine, or asparagine (P>0.05). In the second analysis, urinary Arg was greater in the GAA+Met group compared to the Cr group (P=0.0091; Table 5B). Urinary glutamine was greater in the Arg+Met group compared to the GAA group (P=0.0240), while urinary glutamate was greater in the Arg+Met group compared to GAA and GAA+Met groups (P=0.0493). Urinary Met was greater in GAA+Met compared to the GAA, Cr, and control groups, with Arg+Met being intermediate (P=0.0037).

TABLE 4B

| | Treatment | | | |
|---|---|---|---|---|
| Amino Acids | Control | Creatine | Arg + Met | |
| (uM) | (n = 13) | (n = 13) | (n = 14) | P(trt) |
| Alanine | 16.5 ± 2.10 | 15.5 ± 2.05 | 16.3 ± 2.00 | 0.8580 |
| Arginine | 189 ± 24.4^{A} | 131 ± 23.9^{B} | 158 ± 23.8^{AB} | 0.0425 |
| Aspartic acid | 225 ± 25.6 | 238 ± 25.1 | 265 ± 24.6 | 0.1532 |
| Asparagine | 72.3 ± 11.4 | 66.4 ± 11.3 | 63.4 ± 11.2 | 0.5214 |
| Cystine | 165 ± 16.4 | 155 ± 15.9 | 146 ± 15.5 | 0.5010 |
| Glutamate | 70.6 ± 24.8^{B} | 58.5 ± 23.7^{B} | 159 ± 22.8^{A} | 0.0060 |
| Glutamine | 124 ± 24.5 | 99.3 ± 24.1* | 145 ± 23.8** | 0.0716 |
| Glycine | 391 ± 28.9^{AB}** | 417 ± 28.0^{A} | 318 ± 28.0^{B}* | 0.0089 |
| Histidine | 112 ± 17.6 | 97.3± 17.1 | 117 ± 16.7 | 0.4106 |
| Isoleucine | 7.52 ± 1.54 | 8.71 ± 1.51 | 6.96 ± 1.48 | 0.5264 |
| Leucine | 11.8 ± 2.44 | 14.4 ± 2.38 | 11.5 ± 2.32 | 0.4515 |
| Lysine | 189 ± 31.3 | 182 ± 30.0 | 243 ± 28.8 | 0.2757 |
| Methionine | 35.6 ± 17.1^{B} | 35.6 ± 16.4^{B} | 142 ± 17.1^{A} | <0.0001 |
| Phenylalanine | 36.3 ± 4.70 | 37.6 ± 4.55 | 35.8 ± 4.42 | 0.9346 |
| Proline | 2003 ± 254^{A} | 2042 ± 252^{A} | 1628 ± 250^{B} | 0.0034 |
| Serine | 436 ± 35.0 | 405 ± 34.1 | 410 ± 34.1 | 0.6077 |
| Taurine | 3523 ± 314^{A} | 2970 ± 306^{AB} | 2730 ± 298^{B} | 0.0503 |
| Threonine | 458 ± 51.7 | 450 ± 50.3 | 412 ± 48.9 | 0.6036 |
| Tryptophan | 89.9 ± 11.0 | 88.2 ± 10.7 | 79.6 ± 10.5 | 0.4491 |
| Tyrosine | 283 ± 41.8 | 282 ± 41.2 | 261 ± 40.6 | 0.6283 |
| Valine | 2308 ± 387 | 2148 ± 387 | 2244 ± 392 | 0.7681 |

^{A,B}Different letters within the same row indicate statistical significance (P < 0.05);
*Indicate trends (0.05 < P < 0.10). Abbreviations: SEM = standard error of the mean, trt = treatment.

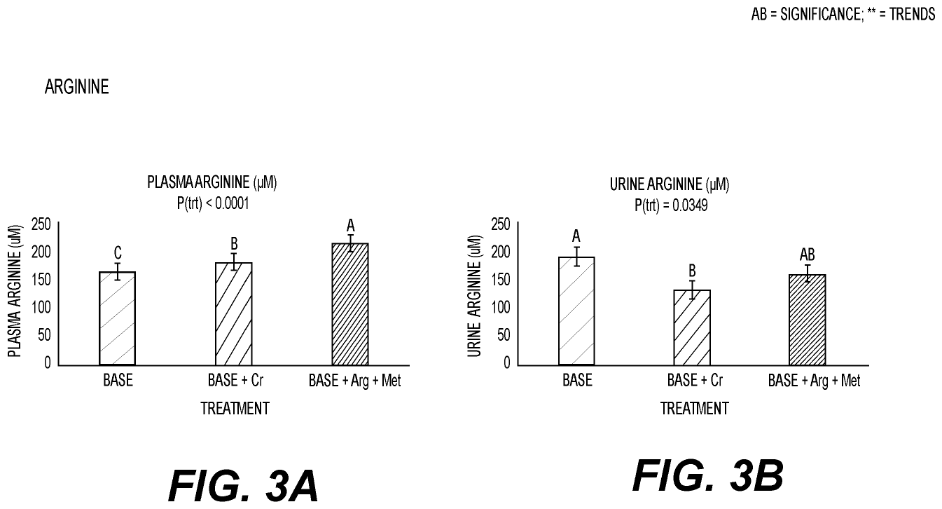

Referring to FIGS. 3A-3B, plasma and urine arginine concentrations from the dietary supplementation study in cats are presented across two panels showing the effects of the three dietary treatments on arginine metabolism. FIGS. 3A-3B depict bar graphs comparing the base diet (BASE), the base diet supplemented with creatine (BASE+Cr), and the base diet supplemented with arginine plus methionine (BASE+Arg+Met) across plasma and urine arginine parameters.

FIG. 3A shows plasma arginine concentrations measured in micromolar units for the three dietary treatments. The plasma arginine concentration in cats receiving the arginine plus methionine supplemented diet was significantly greater than the plasma arginine concentrations in cats receiving either the creatine-supplemented diet or the base diet control (P<0.0001). This higher plasma arginine concentration may indicate that creatine supplementation increases available arginine in companion animals by reducing the metabolic demand for endogenous creatine synthesis, thereby sparing arginine that would otherwise be consumed in the arginine: glycine amidinotransferase reaction that produces GAA.

With continued reference to FIG. 3B, urine arginine concentrations measured in micromolar units are shown for the three dietary treatments. The BASE treatment displayed the highest urine arginine concentration with a treatment p-value of 0.0349. The urine arginine concentration in cats receiving the creatine-supplemented diet was significantly lower than the urine arginine concentration in cats receiving the base diet control. The reduced urine arginine concentration observed in cats receiving creatine supplementation, combined with the higher plasma arginine concentration observed in the same treatment group, suggests increased arginine utilization following creatine supplementation. The pattern of higherplasma arginine and lower urine arginine in cats receiving creatine supplementation may indicate that the spared arginine is being utilized for physiological processes rather than being excreted in urine.

The arginine results presented in FIGS. 3A-3B demonstrate that creatine supplementation may provide an arginine sparing effect in cats. The combination of higher plasma arginine concentrations and reduced urine arginine concentrations in cats receiving creatine supplementation indicates that creatine supplementation may increase arginine availability while simultaneously promoting increased arginine utilization for physiological functions. The arginine sparing effect of creatine supplementation may be particularly relevant in cats, which have limited capacity for endogenous arginine synthesis and have higher arginine requirements compared to omnivorous monogastric species due to increased urea cycle activity.

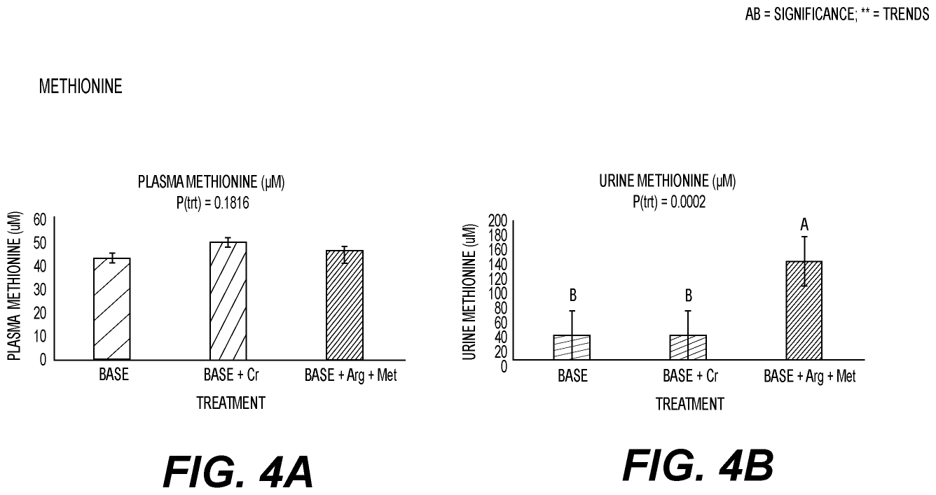

Referring to FIGS. 4A-4B, plasma and urine methionine concentrations from the dietary supplementation study in cats are presented. FIG. 4A shows plasma methionine concentrations with a treatment p-value of 0.1816, wherein no statistically significant differences were observed among the three dietary treatments. FIG. 4B shows urine methionine concentrations with a treatment p-value of 0.0002, wherein the BASE+Arg+Met treatment displayed an approximately 4-fold greater than the BASE and BASE+Cr treatments). The higher urine methionine in the arginine plus methionine supplemented group indicates that excess dietary methionine may be excreted rather than retained for metabolic utilization.

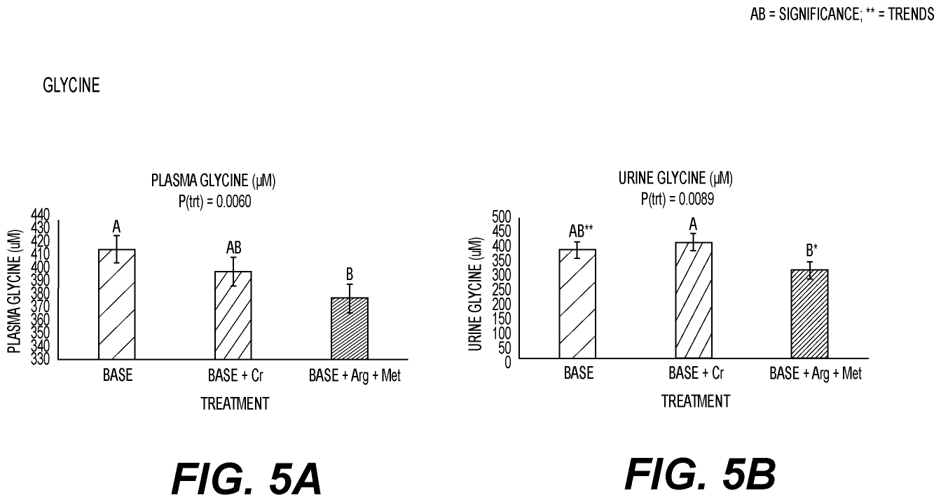

Referring to FIGS. 5A-5B, plasma and urine glycine concentrations from the dietary supplementation study in cats are presented across two panels showing the effects of the three dietary treatments on glycine metabolism. FIG. 5A depicts plasma glycine (Gly) concentrations for the three dietary treatments, wherein the BASE treatment displayed the highest plasma glycine concentration. FIG. 5B depicts urine glycine concentrations for the three dietary treatments, wherein the BASE+Cr treatment displayed the highest urine glycine concentration. The plasma glycine concentration in cats receiving the base diet control was significantly greater than the plasma glycine concentration in cats receiving the arginine plus methionine supplemented diet, while the creatine-supplemented diet displayed an intermediate plasma glycine concentration (P=0.0060).

The intermediate plasma glycine and higher urine glycine concentrations observed in cats receiving creatine supplementation may reflect reduced glycine utilization for endogenous creatine synthesis, wherein the glycine that would otherwise be consumed in endogenous GAA synthesis through the arginine: glycine amidinotransferase reaction may be excreted rather than accumulating in circulation. The reduced plasma and urine glycine concentrations observed in cats receiving the arginine plus methionine supplemented diet may reflect increased glycine utilization when excess arginine is available, wherein the provision of excess dietary arginine may increase flux through the arginine: glycine amidinotransferase reaction, resulting in increased glycine consumption for GAA synthesis, although this increased GAA production may not translate to increased creatine pool size in cats as evidenced by the urine creatine and creatinine data presented in FIGS. 2A-2C.

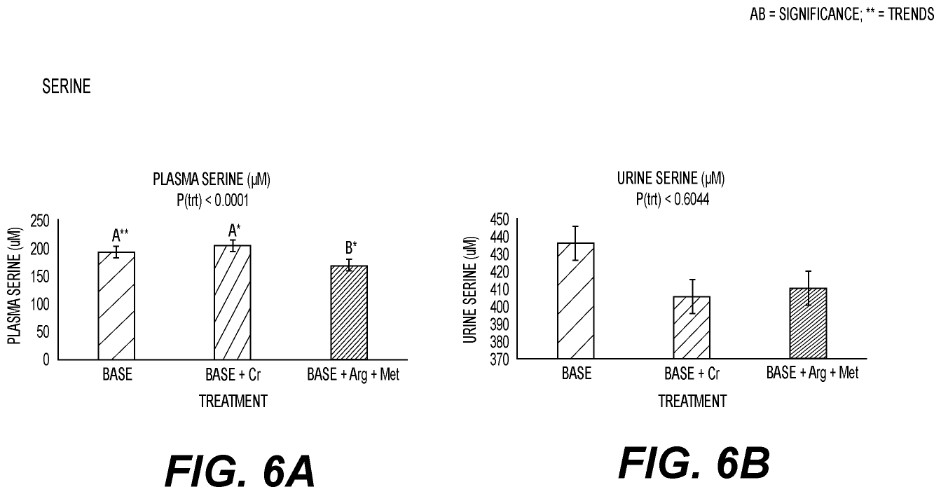

Referring to FIGS. 6A-6B, plasma and urine serine concentrations from the dietary supplementation study in cats are presented. FIG. 6A shows plasma serine concentrations measured in micromolar units for the three dietary treatments with a treatment p-value of less than 0.0001, wherein the BASE+Cr treatment displayed the highest plasma serine concentration. The elevated plasma serine concentration observed in cats receiving creatine supplementation may support cognitive function in companion animals, as serine is an amino acid that may improve problem solving ability, spatial memory, and learning capacity in mammals, and may prevent stress-related cognitive deficits and age-related cognitive decline. Increased Ser may improve problem solving, spatial memory and learning, and prevents stress and age-related cognitive deficits. Increased Cr may enhance memory, attention, processing speed, intelligence and reasoning, especially in older and stressed individuals. Combined, Ser and Cr may enhance cognitive function and help to slow, stop, or reverse cognitive decline, particularly in aging and stressed individuals. FIG. 6B shows urine serine concentrations with a treatment p-value of 0.6044, wherein no statistically significant differences were observed among the three dietary treatments. The combination of elevated plasma serine concentration and similar urine serine concentration in cats receiving creatine supplementation suggests that the increased circulating serine may be retained and utilized for physiological functions rather than being excreted, which may support cognitive health in companion animals through the combined effects of creatine supplementation on both creatine and serine metabolism.

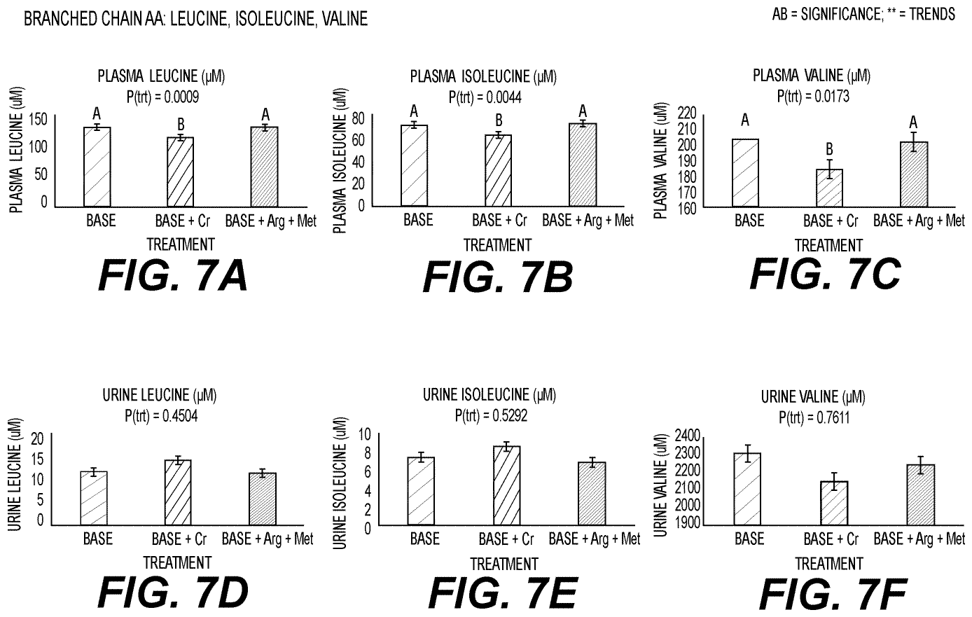

Referring to FIGS. 7A-7F, plasma and urine branched-chain amino acid (BCAA) concentrations from the dietary supplementation study in cats are presented. FIGS. 7A-7C show plasma concentrations of leucine, isoleucine, and valine, wherein cats receiving the creatine-supplemented diet displayed significantly lower plasma BCAA concentrations compared to cats receiving either the base diet control or the arginine plus methionine supplemented diet (p-values of 0.0009, 0.0044, and 0.0173, respectively). The reduced plasma BCAA concentrations observed in cats receiving creatine supplementation may reflect increased utilization of BCAAs for muscle protein synthesis, wherein creatine supplementation may enhance the anabolic environment in muscle tissue by supporting ATP availability through the creatine kinase/phosphocreatine system. FIGS. 7D-7F show urine BCAA concentrations, wherein no statistically significant differences were observed among the three dietary treatments (p-values of 0.4504, 0.5292, and 0.7611, respectively). The combination of reduced plasma BCAA concentrations and similar urine BCAA concentrations in cats receiving creatine supplementation suggests that the BCAAs may be utilized for physiological functions rather than being excreted, which may support muscle protein synthesis, muscle repair, and muscle growth in companion animals receiving creatine-supplemented food compositions, and may be particularly relevant for senior companion animals experiencing age-related muscle loss, and injured companion animals requiring muscle recovery support.

### Results

Plasma Arg was greatest in the Arg+Met group, as a result of supplementation of Arg, followed by the Cr group, then the control. This suggests that exogenous Cr downregulates endogenous synthesis, reducing Arg utilization within the Cr biosynthetic pathway, compared to the control, increasing the availability of circulating Arg. Consistent with this, urinary Arg was lower in the Cr group compared to the control and Arg+Met groups, indicating that Cr supplementation increased plasma Arg without exceeding metabolic demand. In contrast, Arg+Met supplementation appeared to supply Arg in excess of immediate metabolic demand, resulting in urinary excretion. With no plasma differences, this suggests that Met status is highly regulated in the plasma and that urinary AA must be considered to identify when there is a surplus. When considered alongside urinary Met excretion, which was elevated in the Arg+Met group, this suggests a similar pattern to Arg in which Arg+Met supplementation provided more Met than could be immediately utilized, resulting in overflow excretion, whereas Cr supplementation appeared to allow Met to be retained in circulation without increased urinary losses.

Plasma Gly was greater in the control group compared to the Arg+Met group, while concentrations in the Cr group were intermediate. This pattern may indicate that when Arg and Met are supplied in excess, Gly is more extensively utilized or redirected toward other metabolic pathways. Conversely, the greater plasma Gly in the control group may reflect limited precursor availability, reducing its diversion and resulting in accumulation in the plasma. This interpretation is further supported by the lower urinary Gly excretion in the Arg+Met group compared to the Cr group, and a tendency toward lower excretion compared with the control, indicating greater utilization and less spillage.

The levels of branched-chain AAs (BCAAs), leucine, isoleucine, and valine, in plasma were greater in the control and Arg groups compared to the Cr group. The BCAAs are rapidly taken up by skeletal muscle to support protein synthesis and prevent protein breakdown, as such, the lower circulating BCAAs in the Cr group may suggest increased uptake and utilization for protein synthesis.

Plasma serine was greater in the Cr and control groups compared to the Arg+Met group and tended to be greater in the Cr group compared to the control. Urinary serine did not differ among treatments, suggesting that the greater plasma serine in the Cr group reflects enhanced circulating availability rather than overflow excretion. This may reflect a shift in serine metabolism resulting from reduced endogenous Cr synthesis. Since Cr synthesis consumes methyl groups via S-adenosylmethionine, providing exogenous Cr may lower the methylation burden of this pathway, potentially decreasing the flux through serine-derived one-carbon pathways. This increased availability of circulating serine could promote serinogenesis or reduce serine catabolismleading to greater circulating serine. Conversely, Arg+Met supplementation may increase methylation demand, drawing more serine into one-carbon metabolism and lowering its plasma levels. These results suggest that Cr supplementation may indirectly influence serine metabolism through its interaction with methylation pathways. While these plasma and urine changes do not directly confirm cognitive enhancement, they may point to a potential indirect benefit of Cr supplementation in preserving serine availability for brain health-related pathways. Further studies are warranted to elucidate whether these metabolic shifts translate to functional cognitive improvements. However, these findings are inconsistent with previous work in humans and rodents that did not observe an increase in serine following Cr supplementation.

Plasma Cr and CrN were elevated in the Cr group compared to the Arg+Met and control groups. This indicates that direct supplementation of Cr is necessary to increase whole body Cr concentrations. Providing excess precursor AA alone is not sufficient. This is likely because cats are obligate carnivores with highly active urea cycles, meaning that excess Arg is rapidly utilized to support ammonia detoxification rather than being diverted towards Cr synthesis. In contrast, species like broilers lack a functional urea cycle and prioritize rapid growth and muscle accretion, allowing excess Arg to be redirected towards Cr production. Cr supplementation at the level carried out in this work (200 mg/kg BW) appeared to exceed immediate metabolic demand, as evidenced by increased urinary Cr and CrN excretion. However, during longer term supplementation, the muscle and brain Cr pools may likely increase. This accumulation would lead to less excretion, until the stores are fully saturated. Once the muscle and brain stores are fully saturated, the body reaches a new equilibrium. More research is needed to understand the saturation and equilibrium dynamics of Cr metabolism in cats, including how long it takes for these pools to become saturated, how this varies with dose, and how it may differ from other species.

Although there were no significant treatment effects on RQ, Cr supplementation tended to lower RQ compared to control, suggesting a potential shift toward greater fatty acid oxidation and reduced carbohydrate reliance.

A number of implementations have been described. Nevertheless, it will be understood that various modifications may be made without departing from the spirit and scope of the disclosure. Accordingly, other implementations are within the scope of the following claims.

1. A method of promoting wellbeing of a companion animal, the method comprising:
administering to the companion animal a food composition comprising at least one supplement, wherein the at least one supplement includes creatine, guanidinoacetate, arginine, methionine, or a combination thereof.

2. The method of claim 1, wherein the companion animal is selected from a cat, a horse, a rabbit, a ferret, or a guinea pig.

3. The method of claim 2, wherein the companion animal is a cat.

4. The method of claim 2, wherein the companion animal is a horse.

5. The method of claim 1, wherein the at least one supplement includes creatine at a concentration from about 0.001% to about 2% by weight of the food composition.

6. The method of claim 1, wherein the at least one supplement includes creatine at a concentration from about 0.001% to about 1% by weight of the food composition.

7. The method of claim 1, wherein the at least one supplement includes guanidinoacetate at a concentration from about 0.001% to about 1% by weight of the food composition.

8. The method of claim 1, wherein the at least one supplement is provided at a dosing range from about 10 mg to about 400 mg per kg of body weight of the companion animal.

9. The method of claim 1, wherein promoting wellbeing comprises at least one of improving muscle composition, enhancing exercise performance, supporting muscle recovery, increasing energy expenditure, increasing lean body mass, supporting cardiac health, enhancing cognition, or reducing inflammation.

10. The method of claim 9, wherein promoting wellbeing comprises increasing fatty acid oxidation.

11. The method of claim 1, wherein the food composition is formulated as a dry kibble, a wet food, a treat, or a dietary supplement.

12. The method of claim 1, wherein the at least one supplement includes guanidinoacetate, and wherein the method further comprises supplementation with excess methionine to support conversion of the guanidinoacetate to creatine.

13. The method of claim 1, wherein the at least one supplement includes creatine, and wherein administering the food composition results in an arginine sparing effect in the companion animal.

14. A food composition for a companion animal, the food composition comprising:
a base diet; and
at least one supplement selected from the group consisting of creatine, guanidinoacetate, arginine, methionine, and combinations thereof,
wherein the at least one supplement is present at a concentration of at least 0.001% by weight of the food composition.

15. The food composition of claim 14, wherein the at least one supplement includes creatine at a concentration from about 0.001% to about 1% by weight of the food composition.

16. The food composition of claim 14, wherein the at least one supplement includes guanidinoacetate at a concentration from about 0.001% to about 1% by weight of the food composition.

17. The food composition of claim 16, wherein the guanidinoacetate exhibits losses of less than 1% post-extrusion and less than 10% after storage at 25° C. for 15 months.

18. The food composition of claim 14, wherein the at least one supplement includes a combination of arginine and methionine.

19. The food composition of claim 14, wherein the food composition is formulated as a dry kibble, a wet food, a treat, or a dietary supplement.

20. The food composition of claim 14, wherein the companion animal is a cat.
